(19) United States
(12) Patent Application Publication
(10) Pub. No.: US 2012/0253866 A1
(43) Pub. Date: Oct. 4, 2012

(54) ORGANIZATION OF REVERSE FLEXIBLE MEETING SCHEDULES

(76) Inventor: David W. Hill, Toronto (CA)

(21) Appl. No.: 13/246,243

(22) Filed: Sep. 27, 2011

Related U.S. Application Data
(63) Continuation of application No. 12/379,192, filed on Feb. 13, 2009, now abandoned.

(51) Int. Cl. G06Q 10/06

(52) U.S. Cl. 705/7.12

(57) ABSTRACT

A method and system for scheduling a meeting between a schedule entity and a plurality of booking entities over a communications network. The method comprises presenting a meeting schedule of the schedule entity for access by the plurality of booking entities, such that the meeting schedule defines a meeting period including a start time and an end time and the meeting period is divided into a first meeting interval and a second meeting interval such that the intervals are located in the meeting period between the start and end times. The method also confirms booking of a first meeting for a first booking entity of the plurality of booking entities in the first meeting interval and maintains the availability of the first meeting interval to accept another meeting booking by another booking entity of the plurality of booking entities based on a booking number threshold defining the maximum number of allowed meeting bookings for the first meeting interval. The method also confirms a second meeting for a second booking entity of the plurality of booking entities in the same first meeting interval.

(This is a continuation of U.S. patent application Ser. No. 12/379,192, filed Feb. 13, 2009, which claims priority from U.S. Provisional Application No. 61/272,010, filed Aug. 6, 2009, herein incorporated by reference).

### FIELD OF THE INVENTION

This invention relates to organization of events such as meetings between two or more entities.

### BACKGROUND OF THE INVENTION

There are a number of market sectors with fragmented workforces, such as in the healthcare sector with physicians to nurses to practice administrators. Day to day work in the fragmented workforces can also be highly irregular and unpredictable, and with so many different parts working in isolation there are limited opportunities for people to be exposed to one another. Further, with very few networks supporting these people or groups in reaching out and connecting with each other, it's easy for them to become isolated. All of this makes it very difficult for workers in the fragmented workforces to get in touch with who they want when they need to, to stay in touch with colleagues and coworkers, and to coordinate productive interactions with each other.

For example, research by pharmaceutical companies shows the top prescribing physicians see more than 40 patients per day, and many see more that 70 patients per day. These are extremely busy persons, working in a highly unpredictable and irregular environment. With limited means of reaching out to physicians and time constraints making it increasingly difficult to coordinating interactions, companies and nurses struggle to connect with physicians. It's tough for other healthcare professionals to develop strong relationships with physicians. Further, company representatives had a particularly difficult time and the companies usually take a back seat to the sales representatives in building and nurturing these relationships. Companies also have limited success in monitoring the sales force. Therefore, companies usually do not know when, or even if, customer relationships are in jeopardy or are damaged.

Currently in these fragmented workforces, many business professionals have very little time to meet with company sales representatives (e.g. vendors). This is unfortunate, because potential business customers (customers) may not be made aware of valuable information and insight on new products and existing products. For time strapped customers (such as physicians, nurses, and practice administrators) sales representative calls can be very difficult and resource intensive to attempt to schedule. As scheduling appointments can be just too difficult, it often becomes necessary for vendors to just drop in on the customers whenever they get a chance. This can be distracting to customers as multiple vendors may drop in around the same time and/or may stack up on one particular day.

The wait time to see customers has also increased, with so many vendors calling on the customers, and many vendors are turned away. Further, when a vendor does get some face time with a customer, it is often short and unpredictable such that the information exchange is not as productive as it could be.

### SUMMARY OF THE INVENTION

It is an object of the present invention to provide a reverse meeting organizational environment to obviate or mitigate at least some of the above-presented disadvantages.

Accordingly, one needed environment is an environment in which meetings between entities is coordinated in a dynamic fashion.

Wait time to see customers has increased, with so many vendors calling on the customers at inappropriate time(s), and many vendors are turned away. Further, when a vendor does get some face time with a customer, it is often short and unpredictable such that the information exchange is not as productive as it could be. Contrary to present scheduling systems, provided is a method and system for scheduling a meeting between a schedule entity and a plurality of booking entities over a communications network. The method comprises presenting a meeting schedule of the schedule entity for access by the plurality of booking entities, such that the meeting schedule defines a meeting period including a start time and an end time and the meeting period is divided into a first meeting interval and a second meeting interval such that the intervals are located in the meeting period between the start and end times. The method also confirms booking of a first meeting for a first booking entity of the plurality of booking entities in the first meeting interval and maintains the availability of the first meeting interval to accept another meeting booking by another booking entity of the plurality of booking entities based on a booking number threshold defining the maximum number of allowed meeting bookings for the first meeting interval. The method also confirms a second meeting for a second booking entity of the plurality of booking entities in the same first meeting interval, wherein the meeting intervals are restricted from accepting one or more further meeting bookings based on a comparison of their respective booking number threshold with a total number of booked meetings in the respective meeting interval.

A first aspect provided is a method for scheduling a meeting between a schedule entity and a plurality of booking entities over a communications network, the method comprising the steps of: presenting a meeting schedule of the schedule entity for access by the plurality of booking entities, the meeting schedule defining a meeting period including a start time and an end time, the meeting period being divided into a first meeting interval and a second meeting interval such that the intervals are located in the meeting period between the start and end times; confirming booking of a first meeting for a first booking entity of the plurality of booking entities in the first meeting interval; maintaining the availability of the first meeting interval to accept another meeting booking by another booking entity of the plurality of booking entities based on a booking number threshold defining the maximum number of allowed meeting bookings for the first meeting interval; and confirming a second meeting for a second booking entity of the plurality of booking entities in the same first meeting interval; wherein the meeting intervals are restricted from accepting one or more further meeting bookings based on a comparison of their respective booking number threshold with a total number of booked meetings in the respective meeting interval.

A second aspect provided is a system for scheduling a meeting between a schedule entity and a plurality of booking entities over a communications network, the method comprising the steps of: a presentation module for presenting a meeting schedule of the schedule entity for access by the plurality of booking entities, the meeting schedule defining a meeting period including a start time and an end time, the meeting period being divided into a first meeting interval and a second meeting interval such that the intervals are located in the meeting period between the start and end times; and a scheduler module for confirming booking of a first meeting for a first booking entity of the plurality of booking entities in the first meeting interval, and further configured for maintaining the availability of the first meeting interval to accept another meeting booking by another booking entity of the plurality of booking entities based on a booking number threshold defining the maximum number of allowed meeting bookings for the first meeting interval, and further configured for confirming a second meeting for a second booking entity of the plurality of booking entities in the same first meeting interval; wherein the meeting intervals are restricted from accepting one or more further meeting bookings based on a comparison of their respective booking number threshold with a total number of booked meetings in the respective meeting interval.

A further aspect provided is where the first meeting interval and the second meeting intervals are distributed as overlapping intervals in the meeting period, such that an interval end time of the first meeting interval is defined after an interval start time of the second meeting interval where the first meeting interval is positioned before the second meeting interval in the meeting period.

### BRIEF DESCRIPTION OF THE DRAWINGS

Exemplary embodiments of the invention will now be described in conjunction with the following drawings, by way of example only, in which:

FIG. 1 is a block diagram of components of an meeting organizational environment;

FIG. 2 shows an example configuration of a organizer engine of the environment of FIG. 1;

FIG. 3 is a block diagram of an example computing device for implementing the components of the environment of FIG. 1 and FIG. 10;

FIG. 4a shows an example user interface for a first entity of the environment of FIG. 1;

FIG. 4b is an alternative embodiment of the user interface of FIG. 4a;

FIG. 4c is a further embodiment of the user interface of FIG. 4a;

FIG. 5 is a flowchart of operation of the engine of FIG. 2; and

FIG. 6 is one embodiment of the meeting period of FIG. 1.

### DETAILED DESCRIPTION OF THE PREFERRED EMBODIMENT(S)

### Meeting Organization System 10

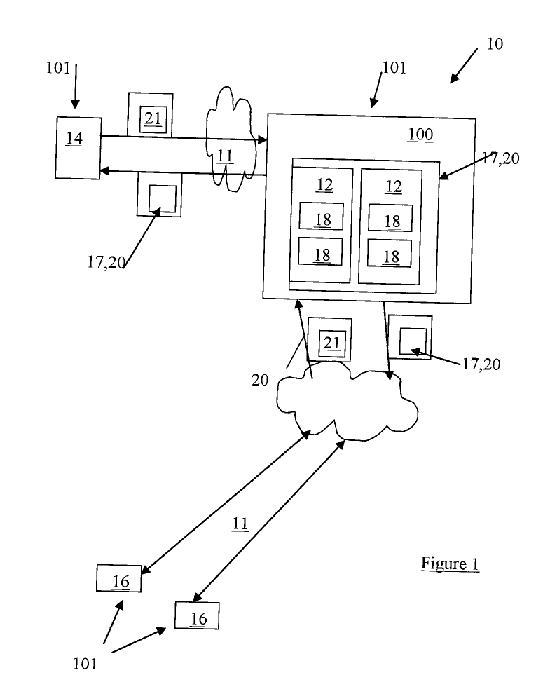

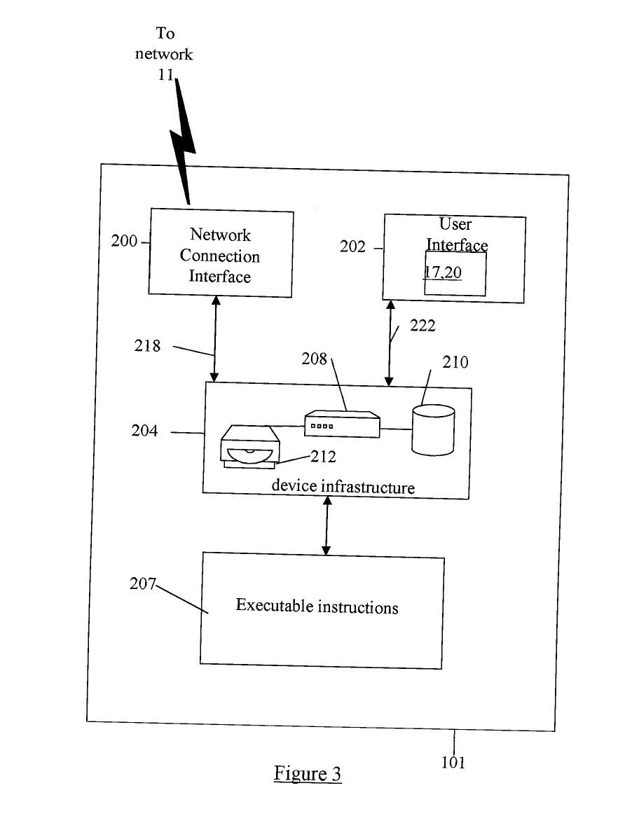

Referring to FIG. 1, shown is a meeting organization system 10 for creating and organizing a plurality of defined meeting periods 12 for a first entity 14 (e.g. a customer) for selection by one or more corresponding second entities 16 (e.g. vendors). An organizer engine 100 coordinates selection of the meeting periods 12 (or portions thereof hereafter referred to as meeting intervals 18) by the second entity 16, once initialized by the first entity 14, as further described below. It is recognised that the organizer engine 100 is accessible to the second entities 16 over one or more interconnected networks 11, such as but not limited to intranet(s) and/or extranet(s) (e.g. the Internet). The organizer engine 100 can be hosted on a computer 101 (see FIG. 3) of the first entity 14 and/or can be hosted on a proxy server 99 remote from the first entity computer 101 for access by both the first entity 14 and the second entities 16 over the network 11. For example, the organizer engine 100 can be provided as a Web service for access by the entities 14,16, as desired. The organizer engine 100 coordinates the scheduling/booking of a plurality of meetings 19 distributed in the meeting intervals 18 of the meeting period 12. It is recognised that the meetings 19 can be conducted in environments such as but not limited to: electronic meetings over the network 11 (e.g. online meeting such as a web conference), meetings; telephone/voice meetings (e.g. via a telephone, verbal communication over the network 11—e.g. Skype™); and/or meetings conducted in person (e.g. an onsite visit in an office of the customer/vendor). It is also recognised that the meetings 19 can be between two or more people (e.g. multiple vendors with one customer, multiple customers with one vendor, etc.), as desired.

Accordingly, communication between the computer devices 101, e.g. of the first entity 14, the second entities 16, the organizer engine 100, is facilitated via the one or more communication networks 11 and implemented by the user through a user interface 202 (see FIG. 3). The system 10 can include multiple user computers 101, multiple organizer engines 100, multiple first entities 14, multiple second entities 16, and one or more coupled communication networks 11, as desired.

### First Entity 14 and Second Entity 16

The first entity 14 interacts with the organizer engine 100 in order to set up the available meeting periods 12 and/or meeting interval(s) 18 that can then be selected by one or more second entities 16 for scheduling of meeting(s) 19. The first entity 14 can be an individual such as a health care worker (e.g. physician) or a group of individuals such as a company or medical clinic/institution having a plurality of health care workers. The second entity(ies) 16 can be individuals and/or groups of individuals (e.g. sales representatives, colleagues of the first entity 14, etc.) that desire to meet with the first entity 14 according to either a specific meeting 19 or a flexible meeting 19 as booked in a period 12/interval 18 situated in the meeting schedule 20 of the first entity 14, as provided by the organizer engine 100. It is also recognised that the second entity 16 can also have a meeting schedule 17 as organized by the organizer module 100 for presenting the various meetings 19 that the second entity 16 has scheduled with one or more other entities 14,16.

For example. multiple vendors 16 can book calls 19 during an available flex call period 12. The number of booked calls 19 within any given time period 12 (and time interval 18) can be limited by the maximum specified by the customer 14. A flex call 19 that has been booked by the vendor 16 is understood as a meeting time when the vendor 16 will be expected to drop in (in the case of in-person meetings 19) to see the customer 14. The organizer engine 100 divides the flex call time period 12 into a number of set length (and overlapping, if needed) windows 18. The vendors 16 who book their flex call 19 can book their call 19 in a selected specific window 18 that is accepting calls 19 in the time period 12. The use of the call windows 18 by the organizer module 100 can facilitate the distribution of the call 19 bookings and can facilitate reduced situations where multiple vendors 16 call on the customer 14 at the same time.

In view of the above, it is recognised that the specific time within the available time of the window 18 when the call 19 is to be made is up to the vendor 16. This facilitates the vendor 16 to choose a time that works best with their schedule, but also provides flexibility to the customer 14 who has no obligation to maintain an exact meeting time for the call 19 within the time period 12 and/or window 18. Also, the actual discussion held within a flex call 19 may have no set length, and can be something that works for both the vendor 14 and the customer 14 at the time of the call 19. The terms window 18 and interval 18 as well as call 19 and meeting 19 are used interchangeably.

One embodiment of the first 14 and second 16 entities has a customer (e.g. first entity 14) and vendor (e.g. the second entities 16) relationship there-between. Therefore, the meeting period 12 (or meeting interval 18) can be configured for one or more sales calls 19 by the vendor(s) 16 to the customer 14, in order to offer vendor products and/or services for purchase/consideration by the customer 14. In the case of healthcare industry, sales person/representative (e.g. the vendors 16) of healthcare/pharmaceutical companies can use the meeting periods 12/intervals 18 as an opportunity to differentiate their healthcare products/services (e.g. medications, medical equipment, etc.) from their competitors and to therefore provide the physician (e.g. customer 14) with important information and/or samples of their products/services. Other examples of first entities 14 (e.g. customers) are such as but not limited to: nurses, practice administrators, institution administrators, etc. For sake of convenience only, the first entity 14 will hereafter be referred to as the customer 14 and the second entities 16 will hereafter be referred to as the vendors 16, by example only. It is also recognised that the meeting organization system 10 can be used by any number of different industry sectors, such as but not limited to: the healthcare sector; the financial sector; the legal services sector; etc, as desired.

For example, either of the first 14 and second 16 entities can be a schedule entity and the other a booking entity, such that the booking entities desire to select and confirm meeting bookings in a meeting schedule 17,20 presented to them (e.g. via the network 11 on a browser), as defined by the schedule entity using schedule parameters 21. It is also recognised that the schedule entity can be a customer role of a customer-vendor relationship between the first 14 and second 16 entities and the booking entity can be a vendor role of the customer-vendor relationship, either existing or potential. It is also recognised that the schedule entity can be a vendor role of a customer-vendor relationship between the first 14 and second 16 entities and the booking entity can be a customer role of the customer-vendor relationship, either existing or potential. It is also recognised that the relationship between the first 14 and second 16 entities can be other than a customer-vendor relationship, such as but not limited to a colleague-colleague relationship, a friend-friend relationship, or any combination of a colleague/customer/friend/vendor or other acquaintance relationship, as desired.

### Meeting Intervals 18 and Meeting Periods 12

As further described below, a specific meeting 19 (e.g. having a first meeting type 22) has a set time of day for the specific meeting 19 to start and a set time of day for the specific meeting 19 to end (e.g. lunch from 12 pm to 1 pm). This is compared to a flexible meeting 19 (e.g. having a second meeting type 22), which has an associated time slot in which the flexible meeting 19 may take place. It is recognised that the flexible meeting 19 may take more or less time than the time duration of the associated time slot (e.g. a flexible meeting 19 can take place in a selected/booked time slot—e.g. meeting interval 18—selected from the meeting period 12 having a possible plurality of time slots). One example is where the meeting interval 18 for the flexible meeting 19 of 10 am to 10:30 am is selected as the meeting interval 18 in the meeting period 12 of 10 am to 12 pm provided in the meeting schedule 20. In this case, it is recognised that the second entity 16 can attend the flexible meeting 19 with the first entity 14 starting approximately in that booked 10 am to 10:30 am time slot. Both the first 14 and the second 16 entity are of the understanding that the flexible meeting 19 may start later than 10 am and may end earlier or later than 10:30 am. For example, the actual discussion of the meeting 19 can take 10-15 minutes (e.g. a portion) of the booked 30 minute time interval 18. The start time of the meeting 19 can also take place later than the start time of the meeting interval 18. It is also recognised that the term slot 18 and interval 18 are also used interchangeably.

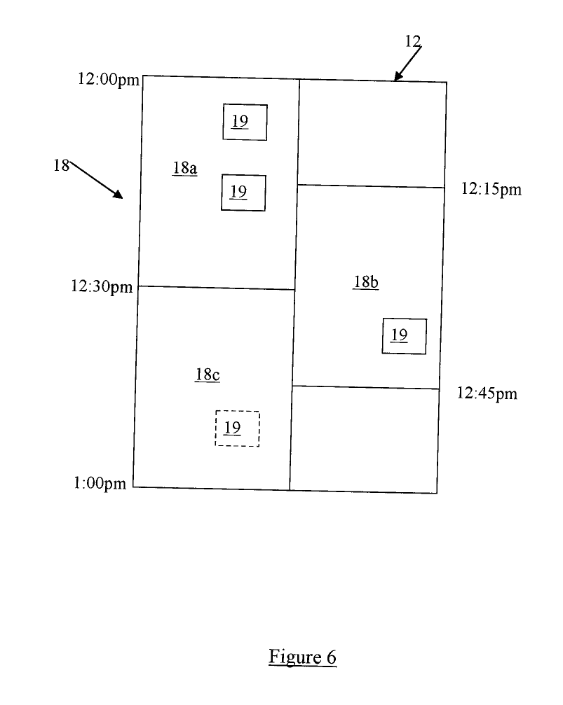

In any event, the first entity 14 desires to meet with one or more of the second entities 16 via a calendar meeting schedule 20 (maintained by the organizer engine 100) that consists of one or more meeting periods 12 (e.g. a predefined block number of minutes and/or hours, see below) distributed over one or more days of selected week(s), month(s), and/or year(s). Within the time span represented by each of the meeting periods 12, there can be further subdivisions of the meeting period 12, referred to as the meeting intervals 18. For example, a meeting period 12 (e.g. one hour) can have one or more meeting intervals 18 (e.g. 30 minute intervals) defined between the start and end time (e.g. from 1 pm to 2 pm) of the meeting period 12. As seen in FIG. 6, each of the booked meetings 19 are in meeting intervals 18 that are distributed over the meeting period 12 by the organizer module 12, according to parameters 21 supplied by the system 10 (e.g. presets) and/or provided by the customer 14, as desired.

In the simple case, the meeting interval 18 of the meeting schedule 20 can be defined as having the same time duration as the meeting period 12, thus providing for one meeting interval 18 in the meeting period 12. For example, a meeting period 12 starting at 1 pm and ending at 1:30 pm would only have one 30 minute meeting interval 18. Otherwise, in the case where the meeting interval 18 of the meeting schedule 20 can be defined as having a time duration greater than that of the meeting interval(s) 18, thus providing for more than one meeting interval 18 per meeting period 12. For example, a meeting period 12 starting at 1 pm and ending at 2 pm would only have two potential 30 minute meeting intervals 18, in the case of non-overlapping 30 minute intervals 18, and more than two potential meeting intervals 18 in the case of overlapping 30 minute intervals 18, as further described below. It is recognised that the meetings 19 themselves are also distributed over the meeting period 12 as a consequence of the distribution of the meeting intervals 18 over the same meeting period 12, a well as the number of allowed meeting 19 bookings per meeting interval 18

It is also recognised that any particular meeting period 12 can be configured to have a plurality of potential meeting intervals 18 of different time durations. For example, the meeting period 12 starting at 1 pm and ending at 2 pm could have available (for selection by the second entity(ies) 16) one or more first meeting intervals 18 of 30 minute duration and one or more second meeting intervals 18 of 15 minute duration, such that the time durations of the multiple respective meeting intervals 18 can be different for any particular meeting period 12, as further described below. It I also recognised that the duration of the individual meetings 19 can be a portion of the duration of the respective meeting period 18 in which the meeting is booked (e.g. a 10 minute meeting 19 can be scheduled to take place anywhere within the 30 minute duration of the respective meeting interval 18). In view of this, it is possible that two different vendors 16 that each have a 10 minute meeting booked in the same or overlapping meeting intervals 18 can both arrive at the same time at the office of the customer 14. In this case, both of the vendors 16 could be cognizant that the start and end time of their actual meeting 19 is also flexible and therefore would be comfortable in having to wait for their meeting 19 to take place.

In view of the above-described meeting organizational system 10, it is recognised that flexible meetings 19 (e.g. of the second meeting type 22) are available for selection by the vendor 16 in those meeting periods 12 that have a plurality of overlapping potential meeting intervals 18, such that each of the overlapping meeting intervals 18 have a time duration that coincides in part with (e.g. to have in common with) the adjacent meeting interval 18. For example, referring to FIG. 6, a meeting period 12 of 60 minutes (e.g. 12 pm to 1 pm) can have three 30 minute duration potential meeting intervals 18, available in the meeting period 12, as overlapping in time duration as the first meeting interval 18a from 12 pm to 12:30 pm, the second meeting interval 18b from 12:15 pm to 12:45 pm, and the third meeting interval 18c from 12:30 pm to 1 pm. In this way, meetings 19 can be booked/scheduled in the 60 minute meeting period 12 using the distribution of the overlapping meeting intervals 18, as further described below.

Further to the above, it is recognised that the meeting period 12 and/or the meeting intervals 18 can be adjusted to enable customers 14 to customize the meeting intervals 18 to any length in time (i.e. time duration), such as but not limited to a specified number of minutes, portions of an hour, portions of a day, multiple hours, multiple days, etc.

### Meeting Types 22

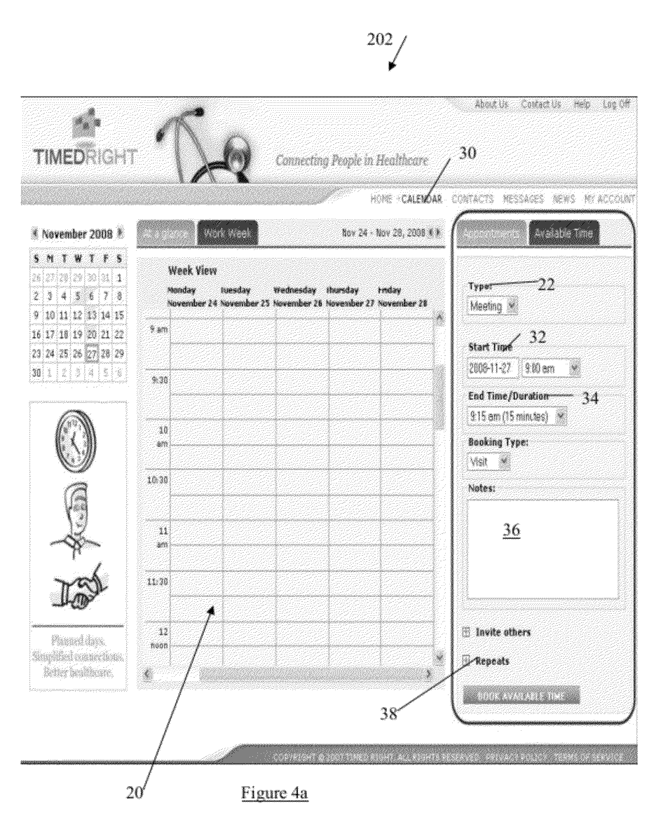

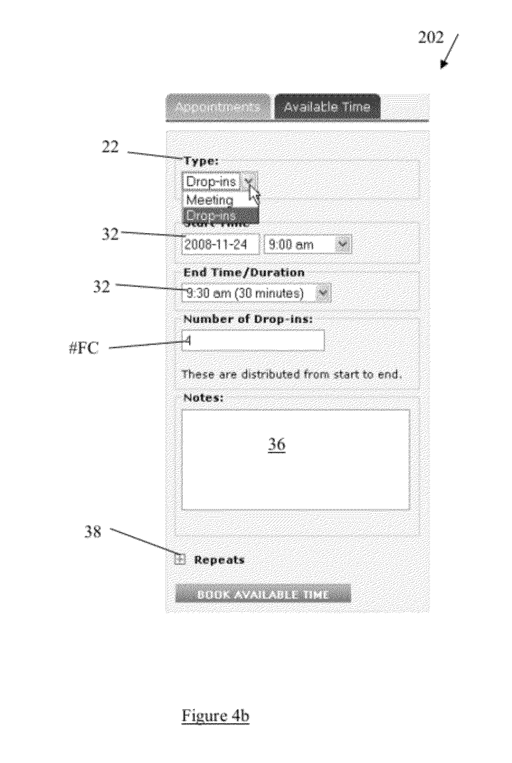

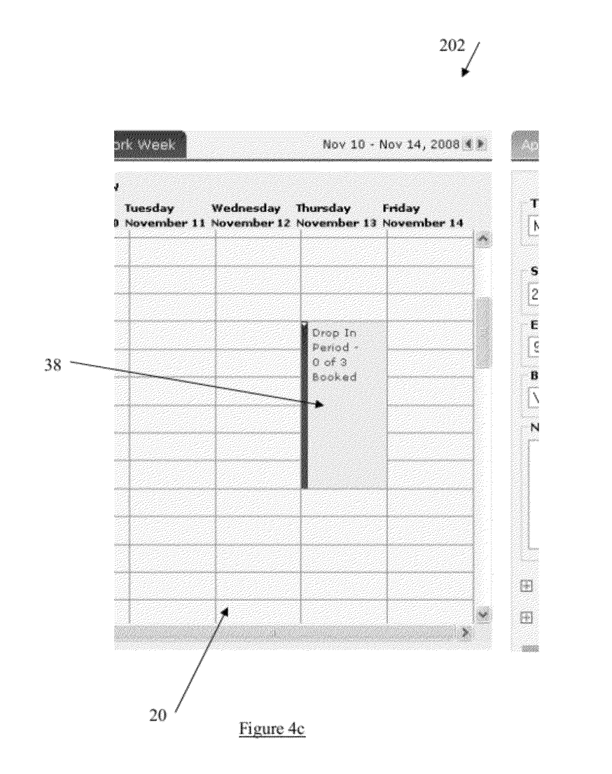

It is recognised that any particular meeting period 12 and/or meeting interval 18 can be defined as a first meeting type 22, a second meeting type 22, etc, as represented in meeting parameters 21 associated with the respective customer 14, see FIG. 4a. For example, the first meeting type 22 (e.g. a specific meeting 19) is where only one vendor 16 can book a meeting 19 in the meeting period 12 and/or meeting interval 18, as provided in the meeting schedule 20 of the customer 14. The second meeting type 22 (e.g. a flexible meeting 19) is where more than one vendor 16 may be allowed to book a respective portion of the meeting period 12/interval 18 provided in the meeting schedule 20 of the customer 14.

For the first meeting type 22 (e.g. the specific meeting 19) the customer 14 simply sets up (via the meeting engine 100) when the customer 14 wants the vendor 16 to come (e.g. 10 to 10:15 am on Wednesday or 12:30 to 1:30 pm for lunch on Thursday). Once the meeting 19 in the meeting period 12 or interval 18 is selected (e.g. booked) by the vendor 16, the meeting engine 100 does not allow any other vendors 16 to select/book meetings 19 in that meeting period 12/interval 18.

For the second meeting type 22 (e.g. a flexible call/meeting 19), the customer 14 has defined via the meeting parameters 21 that the particular meeting period 12 is to be subdivided into a number of the meeting intervals 18, such that the customer 14 has indicated that they will accept a number of drop in calls 19 (e.g. between 1 pm and 3 pm on Fridays they would accept up to three flex calls 19). For example, meeting(s) 19 can be booked in the meeting intervals 18 by a particular vendor 16, as further described below. Once the particular meeting 19 in a selected interval 18 is booked by the vendor 16, the organizer engine 100 may or may not allow any other vendors 16 to select/book meetings 19 in that booked meeting interval 18, depending on the allowed maximum number of meeting 19 bookings for any particular meeting interval 18. This maximum may be driven by the maximum that the customer 14 sets for a particular interval 18, or may be driven by the maximum the customer sets for the entire period 12. In this case, the system adjusts the maximum in all slots in real time, and the system may be required to distribute the calls as best it can (such that no interval 18 has more than a selected number (e.g. 1) call 19 difference from another in the entire period 12) or the system may not require distribution meaning that one interval 18 within the period 12 could be booked up with multiple calls 19 while another interval 18 has none.

It is also recognised that an alternative embodiment is where the organizer engine 100 would facilitate the booking of a meeting 19 by multiple vendors 16 in the same meeting period 12 and/or meeting interval 18 (e.g. an event situation for a flexible meeting type 22, an event situation for a specific meeting type 22, etc.).

### Organizer Engine 100

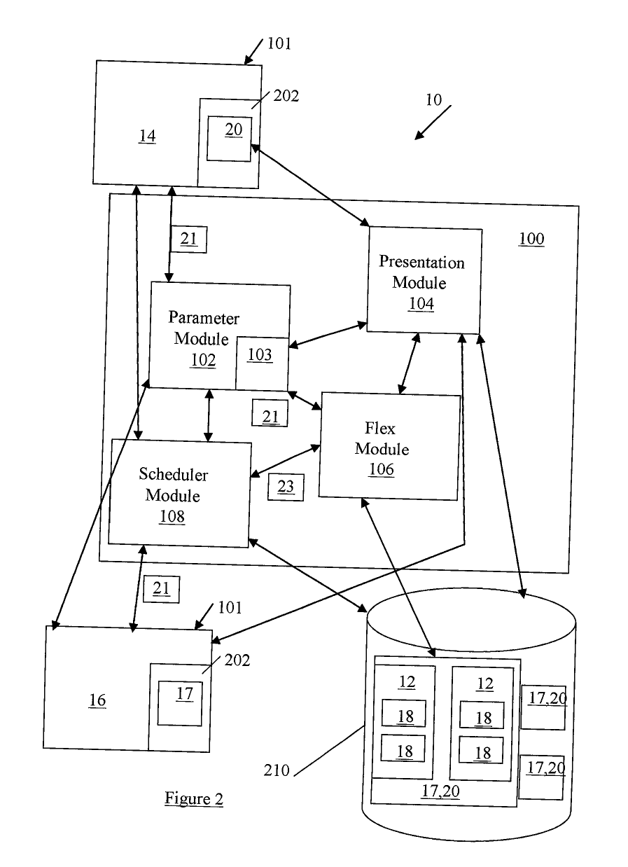

Referring to FIG. 2, the organizer engine 100 of the system 10 configures and manages and the meetings 19 in the meeting periods 12/intervals 18 of the meeting schedules 20 for each of the customers 14. The available time process of the organizer engine 100 allows members of meeting organization system 10, who are connected with each in a vendor 14 and customer 16 relationship, to coordinate their meeting interactions. The process provides for customers 14 to identify in their meeting schedule 20 when they have available time (e.g. for first and/or second type 22 meetings—see FIG. 4a) for vendors 16 to meet with them. For meetings of the first meeting type 22, the customer 14 simply sets up when they want the vendor(s) 16 to meet with them (e.g. 10 to 10:15 am on Wednesday or 12:30 to 1:30 pm for lunch on Thursday). This is compared to meetings of the second meeting type 22, which are defined in the meeting schedule 20 as periods of time that the customer 14 has indicated they will accept a number of booked flexible meetings 19 (e.g. between 1 pm and 3 pm on Fridays the customer 14 would accept up to three meetings 19 distributed over four meeting intervals 18). The organizer engine 100 can also manage and maintain vendor centric meeting schedules 17 that present the meetings 19 of the vendor 16 scheduled with various customers 14.

Referring again to FIG. 2, the meeting periods 12/intervals 18 are defined by the customer 14, via meeting parameters 21 using a parameter module 102, for selection by one or more vendors 16 via the network 11 for booking/confirming of meeting 19. For example, the meeting parameters 21 can contain a list of all authorized vendors 16 that are allowed to view and/or select the meeting periods 12/intervals 18 belonging to the respective customer 14, as part of the meeting organization system 10. The meeting parameters 21 can contain a unique identity (e.g. user name or other unique identifier of the particular vendor 16) of the authorized vendor(s) 16 for use by the organizer engine 100 in providing access by only the authorized vendors 16 to the meeting schedule 20 of the customer 14. Otherwise, or in addition to, the meeting parameters 21 can contain a generic identity (e.g. a specified vendor company, a specified product name/type provided by the vendor, a specified service name/type provided by the vendor, etc.) of the authorized vendor(s) 16 for use by the organizer engine 100 in providing access by only the authorized vendors 16 to the meeting schedule 20 of the customer 14.

Further, it is recognised that the customer 14 may have access to vendor schedules 17 that the customer wishes to schedule a meeting 19 with, such that the customer 14 could be able to see open periods of the vendor schedule 17 in which a meeting 19 may be booked. Alternatively, the customer 14 may have access to the open periods of the vendor schedule 17 and would be able to send a meeting invitation for a selected time period and/or meeting period 12 available in the customer schedule 20. Different scenarios are available, such as but not limited to: the customer 14 booking a meeting 19 in the schedule 17 of the vendor 16 (for example, a flex meeting 19 type as described above); the customer 14 requesting that that the vendor 14 book a meeting 19 in the schedule 20 of the customer in one or more specifically suggested time periods/intervals 18; or the customer 14 requesting that the vendor 16 just simply review the schedule 20 of the customer 14 and book a meeting 19 (e.g. for a specified/suggested purpose). For example, the customer 14 can realize that they are low in stock for a particular item available through the vendor 16 and/or the customer 14 has heard about a particular product/service of the vendor 16, and therefore have identified a need to have a meeting 19 with the vendor 16. In any event, in the case of the organizer engine 100 organizing different schedule 17, 20 for both the customers 14 and the vendors 16, the organizer engine 100 would make available meeting 19 information in both the respective schedules 17,20, a particular meetings 19 are booked.

As described above, for example, only members of the meeting organizational system 10 who are connected (e.g. associated via the meeting parameters 21) to the customer 14 as the vendor 16 (and as a customer 14 of the vendor 16) can see specific meetings 19 and/or available flex calls 19 (e.g. in potential meeting intervals 18 in the meeting period(s) 12) available in the meeting schedules 17, 20. For example, authorized vendors 16 who want to book meeting(s) 19 in any open (in the meeting schedule 20 of the customer 14) meeting period(s) 12 and/or meeting interval(s) 18 can do so on a first come first serve basis, and in accordance with any preferences designated by the customer 14 in the meeting parameters 21, as further described below. Accordingly, only one vendor 14 may be able to book (via the organizer engine 100) a single meeting period 12/interval 18 of the first meeting type 22. Once booked, the available meeting period 12/interval 18 could be specified as booked and may not be visible (e.g. for selection) in the meeting schedule 20 to other vendors 16 not associated with the booking vendor 16. It is recognised that the vendor 16 (via a scheduler module 108) or the customer 14 (via the parameter module 102, for example) can cancel the booked meeting period 12/interval 18, which could reopen in the meeting schedule 20 as an available meeting period 12/interval 18 to be booked/selected by a different vendor 16.

Further, it is recognised that multiple vendors 16 can book meetings 19 (of the second meeting type 22) during an available meeting period 12 that has a number of available potential meeting intervals 18 contained within the meeting period 12. The number of booked meeting intervals 18 within the meeting period 12 is limited by an interval number maximum as specified by the customer 14 in the meeting parameters 21. For example, see FIG. 6, in the case of overlapping meeting intervals 18a,b,c available for selection by the vendor 16 in the meeting period 12 (e.g. of 60 minute duration) of the meeting schedule 20, the vendor 16 may be presented with three potential meeting intervals 18 (each of 30 minute duration) distributed with 15 minutes of overlap with the adjacent meeting interval 18. The vendor 16 can see each of the available meeting intervals 18 and can therefore select/book a meeting 19 in one of the available meeting intervals 18. Once booked, the meeting 19 is booked in a selected meeting interval 18, the meeting interval 18 may be removed from the displayed available meeting intervals 18 of the respective meeting period 12.

A meeting 19 that has been booked by the vendor 16 can be defined as a period of time when the vendor 16 can be expected to meet (either in person or on the telephone or other communication device) with the customer 14. The organizer engine 100 divides the meeting period 12 into the number of set length (and overlapping, if desired) potential meeting intervals/windows 18 using the meeting parameters 21. Vendors 16 who book their meeting 19 in one of the meeting intervals 18 have to book the meeting 19 within a specific meeting interval/window 18 provided in the meeting period 12, which can help to distribute vendor 16 bookings and to help reduce situations where multiple vendors 16 call on the customer 16 at the same time. It is recognised that the duration of the meeting 19 can be such as but not limited to: a portion of the duration of the respective meeting interval 18 (e.g. providing for more than one potential meeting 19 in the meeting interval 18); all of the duration of the respective meeting interval 18 (e.g. providing for only one potential meeting 19 in the meeting interval 18); etc.

The specific time (i.e. selection from the available potential meeting interval(s) 18) within the meeting period 12, when the booked customer-vendor meeting 19 is to be conducted, is up to the vendor 16, for example. This enables the vendor 16 to choose a meeting interval 18 that works best with their schedule, but also provides flexibility to the customer 14 who has no obligation to organize an exact meeting 19 time for each of the booked vendors 16. Also, the actual meeting 19 discussion produced within the booked meeting interval 18 may have no set length, thus providing for the ability for the meeting period 12 to contain a plurality of overlapping meeting intervals 18, as further discussed below.

### Parameter Module 102

Referring again to FIG. 2, the parameter module 102 of the organizer engine 100 accepts the meeting parameters 21 from the customer 14 for use in constructing the customer's meeting schedule 20. The parameters 21 can include the specified calendar date(s) for the meeting period(s) 12 (Monday and Wednesday of the current week), the designation of the meeting periods 12 as one of the meeting types 22 (e.g. specific meeting 19 or flexible meeting 19), the start and end times of the meeting period(s) 12 (e.g. 12 pm till 1 pm), specified vendors 16 authorized (e.g. via the unique or generic identifier) to view and therefore book in any of the meeting periods 12 (and/or meeting interval(s) 18 thereof) of the customer's 14 meeting schedule 20, the total number of bookable flexible meetings 19 (e.g. in available meeting intervals 18) that the customer 14 desires in the specified meeting period(s) 12 and/or meeting intervals 18 (e.g. the customer 14 selects a total of 4 flexible meetings 19 for booking in the specified meeting period(s) 12), a limit on a number frequency of a particular vendor 16 (or class of vendor 16) that can book a meeting 19 in a selected calendar period of the schedule 20, a maximum number of meetings 19 that can be booked in any particular time period 12 (e.g. a period booking number threshold) and/or time interval 18 (e.g. an interval booking number threshold), and/or the duration in time of the meeting intervals 18 (e.g. 30 minutes each). It is recognised that any of the above-described meeting parameters 21 can be provided as default parameters 21 by the organizer engine 100 and as such may not be explicitly provided by the customer 14 at the time of setting up their meeting schedule 20.

For example, referring to FIG. 4a, shown is an example customer meeting schedule 20 for use by the customer 14 in setting up their desired meeting period(s) 12 and meeting intervals 18, as displayed on the user interface 202 of the customer computer 101 (see FIG. 3).

Referring again to FIG. 4a, the customer 14 selects a CALENDAR tab 30 and then the display module 104 displays the CALENDAR page of the meeting schedule 20 to the customer via the user interface 202. The CALENDAR page can be available to all members of the system 10, but only USER TYPES that are designated as potential customers 14 (e.g. Physicians, Nurses, and/or Medical Practice Administrators) can have the ability to enter AVAILABLE TIME (e.g. Start Time 32 and End Time 34 used to calculate the duration DUR of the meeting period 12, for example a multiple of 30 minutes) of each of the meeting periods 12 for positioning of the potential/available meeting intervals 18 therein. The customer 14 also selects the meeting type 22, such as the second type for flexible meetings, which provides for a flex module 106 to determine the distribution (e.g. number of flex call windows #FCW) of the available/potential meeting intervals 18 in the specified meeting period(s) 12, further described below. It is recognised that each specified meeting period 12 has a specific start/end time 32,34 and can have a specified meeting type 22.

The customer 14 also specifies the total number #FC of bookable meetings 19 (see FIG. 4b) that the customer 14 desires to be booked within the meeting period(s) 12/meeting intervals 18, as well as the duration(s) of the meeting intervals 18. For example, the customer 14 can specify that the maximum number of drop-ins (e.g. flexible meetings 19) is 4 (i.e. #FC=4) to be distributed in the specified meeting period(s) 12. For example, the flex module 106 can be configured to allow for a maximum number of potential/available meeting intervals 18 to be displayed in any particular specified meeting period 12, for viewing and selection by the vendor 16. For example, the customer 14 may enter no more than two (2) potential/available meetings 19 for every 30 minutes of specified meeting interval 18 (e.g. if the DUR of the time period is two (2) hours, then the customer 14 can enter the maximum number #FC of desired/bookable meetings as eight (8)). It is recognised that this 2 per 30 minutes maximum per meeting interval 18 is a variable that can be changed, as desired.

For example, the user can specify the maximum #FC booking available in an entire period 12, and the system would distribute the booked calls 19 managing for an auto-calculated maximum in any interval 18. For example, a user could set to accept 5 calls over 2 hours (e.g. period 12) where there are 3 one hour flex intervals 18 (with a 30 minute overlap) within the 2 hour period 12. Therefore, with “distribute” turned on, the organizer module 100 would say that the maximum any one interval 18 will accept is 2 (5/3 rounded up.) But all three intervals 18 could be booked with one meeting 19 only, which would leave all three intervals 18 still open for another meeting 19 booking for selection by the vendor 16 (in the case of schedule 20) or the customer 14 (in the case of schedule 17).

Accordingly, any available/potential meeting interval 18 can become a booked/full meeting interval 18 once the threshold of total number of meetings 19 for the respective time interval 18 is reached. Once considered full/booked, the time interval 18 is removed from presentation (e.g. view by the vendor 16) from the presented meeting schedule 20. Accordingly, it is recognised that a particular interval 18 may be considered full (e.g. becoming restricted to any further access by the booking entities) prior to the number of meeting bookings 19 in the interval 18 reaching the interval booking threshold. This process of premature closing of the interval 18 assists in distribution of the booking meetings 19 over a number of the intervals 18 in the time period 12, rather than allowing for an undesirable concentration of booked meetings 19 in only a limited number (e.g. one) of the defined intervals 18 in the period 12.

Referring again to FIG. 4b, the customer 14 can also specify in the meeting parameter 21 notes 36 that give the CUSTOMER 14 the opportunity to let vendors 16 know what they can expect with these meetings 19. Further, if the customer 14 desires to repeat the meeting periods 12 and/or meeting intervals 18 as specified, the customer 14 can input 38 how frequently the specified meeting periods 12 and/or meeting intervals 18 will repeat (e.g. daily. weekly, bi-weekly, monthly, etc. The customer 14 can also set when the repeat will stop.

In view of the above, it is recognised that the customer 14 can see (via the user interface 202—see FIG. 4c) the distribution of meeting intervals 18 as single period of time 38 (e.g. the specified meeting period(s) 12) that indicates the number of meetings 19 already booked or otherwise remaining as not booked by the vendors 16, whereas the vendors 16 who view the flexible type 22 meeting periods 12 will see the available/potential meeting interval(s) 18 (as built by the flex module 106) in the specified meeting periods 12 and their own booked meetings 19 (as displayed by the display module 104), further described below.

Further, it is recognised that the customer 14 can click on a specified meeting period 12 to perform acts (e.g. via the parameter module 102) such as but not limited to: EDIT the DETAILS of the meeting; CLOSE a booking; and/or CANCEL the meeting 19. It is also recognised that the customers 14 can put any number of meeting periods 12 (of any meeting type 22) into their calendar (i.e. meeting schedule 20). One potential constraint is that customers 14 may not overlap the meeting periods 12 with other already specified meeting periods 12, for example. Once the meeting period(s) 12 are specified in the meeting schedule 20, the corresponding meeting intervals 18 are ready for selection/booking by the vendors 16 for individual meetings 19, as further described below.

In view of the above, the presentation module 104 can display the configured meeting schedule 20 to the customer 14, in view of the meeting parameters 21 entered into (i.e. received by) the organizer engine 100 via the parameter module 102.

### Presentation Module 104

The presentation module 104 is configured for interaction/display/presentation of the meeting schedule 20 with the vendor 16 and the customer 16 on their respective user interfaces 202 (see FIG. 3). It is recognised that the presentation module 104 may be separate as shown and/or can be incorporated as part of the functionality of the parameter module 102 and/or the scheduler module 108, as desired. Further, it is recognised that the presentation module can present information of the schedule 17,20 visually and/or aurally to the customer 14, vendor 16 via the user interface 202 of FIG. 3.

### Flex Module 106

Referring again to FIG. 2, the flex module 106 is configured to receive the meeting parameters 21 and to build and distribute the potential/available meeting intervals 18, within the meeting period(s) 12 as defined in the meeting parameters 21.

### Calculation of Number of Potential/Available Meeting Intervals 18

The flex module 106 creates a number #FCW of potential/available meeting intervals 18 for distribution in the defined meeting periods 12 that each have a time duration DUR, as discussed above. If the customer 14 set (e.g. via the provided meeting parameters 21) the available flex call duration DUR of the meeting period 12 at 30 minutes or at or below some other specified minimum time duration DUR, then there may be only one flex call window (i.e. meeting interval 18) created at 30 minutes length or otherwise matching the length of time (i.e. DUR) of the meeting period 12, thereby creating the meeting period 12 as having only one potential/available meeting interval 18 for selection by the vendor 16.

If the customer 14 set the available flex call duration DUR as 60 minutes or longer (i.e. greater than the specified minimum time duration DUR), then the flex module 106 generates each flex call window (e.g. potential/available meeting interval 18) using the specified (via the meeting parameters 21) meeting interval 18 time duration (e.g. 60 minutes long with each meeting interval 18 overlapping the previous by 30 minutes, 30 minutes long with each meeting interval 18 overlapping the previous by 15 minutes, etc.), for example see FIG. 6. Accordingly, based on the specified/allowed overlap time length OVERLAP (e.g. 10 minutes, 15 minutes, 20 minutes, 30 minutes, etc.), the flex module 106 generates the number of available/potential meeting intervals 18 for viewing and selection (e.g. booking) by the vendors 16 from the displayed meeting schedule 20 of the customer 14 they wish to meet with. It is recognised that the OVERLAP variable 21 is a variable 21 that can be set at any unit of time (e.g. by the organizer module 100 as a default and/or by the customer 14 as a desired OVERLAP value), but for demonstrative purposes only the value of OVERLAP is currently described as OVERLAP=30. Accordingly, the flex module 106 calculates the total number of available/potential meeting intervals 18 as:

#FCW=1+((Total DUR—interval DUR)/OVERLAP), where

the Total DUR can be defined as equal to or more than the interval DUR (i.e. time duration of the interval 18), for example. For example, using an OVERLAP of 30 minutes and a total period DUR of 120 minutes, and an interval DUR of 60, the total number available/potential meeting intervals 18 would be three meeting intervals 18 initially displayed to the vendor 16 for selection/booking, namely one at t=0 minutes to t=60 minutes, one at t=30 minutes to t=90 minutes, and one at t=60 minutes to t=120 minutes, for example.

As further described below, once the available/potential meeting intervals 18 are generated and displayed to the vendor 16. It is also recognized that the schedule 17 of the vendor 16 can be configured to contain meeting interval 18 using the method described above for the customer schedule 20, such that the vendor 16 supplies the required parameters to the flex module 106 for use in generating the schedule 17.

Accordingly, in the case of the schedule 20, the vendors 16 can book in any of the open (i.e. not booked) potential/available meeting intervals 18 displayed or otherwise indicated to them (e.g. aurally in the case of interacting with the organizer engine 100 via a communication device such as a telephone, visually via text messages, or a speaker of the computer 101 over the network 11) in any of the meeting period(s) 12 of the customer meeting schedule 20. As further described below, the flex module 106 monitors the potential/available meeting intervals 18 of the meeting period(s) 12 as they become booked and may not allow any one meeting period 12 to accept more vendor 16 bookings than the maximum allowed per window 18 maximum BWmax and/or vendor bookings greater than the maximum for the collection of time intervals 18 (e.g. the respective time period maximum meeting 19 total, #FC)

### Distribution of Booked Meeting Intervals 18

One method implemented by the flex module 106 for distributing booked meetings 19 in the meeting intervals 18 can be done by calculating the maximum number of flex call bookings BWmax of the meetings 19 for any meeting interval 18 as:

BWmax=#FC/#FCW,

such that any fractional value of the BWmax is rounded up to the next integer value, for example. For example, if there are three potential/available meeting intervals 18 (i.e. #FCW=3) per meeting period 12 and the maximum number #FC of bookable meetings 19 defined by the customer 14 is four (i.e. #FC=4) for a selected collection of meeting intervals 18, then the maximum per meeting interval 18 in the schedule 20 is two (i.e. BWmax=2). In this example, in the case where there are three meeting intervals 18 in a meeting collection/group defined by the customer 14 in the meeting schedule 20, then each meeting period 12 would initially contain three potential/available meeting intervals 18 having a total of 4 open meetings (i.e. available for booking by the vendors 16). However, the flex module 106 would only allow any meeting interval 18 to contain up to a maximum (BWmax) of two booked meetings 19 and the total number of booked meetings 19 (#FC) would be 4 distributed across the three meeting intervals 18.

Accordingly, the number of intervals 18 in the period is calculated based on the period booking number threshold (e.g. #FC) and the interval booking number threshold (e.g. #FCW). The booking number threshold defines the maximum number of allowed meeting bookings 19 for the meeting interval 18. The period booking number threshold defines the maximum number of allowed meeting bookings 19 for the meeting period 12, having one or more meeting intervals 18. Accordingly, the use of meeting intervals distributed over the meeting period 12 (either overlapping or non-overlapping) is used by the organizer module 100 to help distribute a plurality of the booking meetings 19 over the meeting period 12, thus helping to inhibit clustering of booking meetings 19 in the meeting period 12.

For example, in the course of booking meetings 19 in the time period 12, the first meeting interval 18 would get the first booked meeting 19. In order to encourage distribution of the meetings 19 over the time period 12, the first meeting interval 18 could remain open (i.e. visible to the vendors 16) in order to accept one of the three remaining available meetings 19 (where the maximum number of meetings 19 of the time period 12 is set at 4 and the maximum number of meetings 19 for the first meeting interval 18 is two). In the case where either the second or third meeting interval 18 gets the second meeting 19, all three meeting intervals 18 of the time period 12 would remain visible in the schedule 20 (by the vendor 16) as the maximum number for any of the time intervals 18 has yet to be reached. Otherwise, in the case where the second meeting 19 was also booked in the first interval 18, the first interval 18 would be at the maximum allowed meetings 19 and therefore could be removed from presented schedule 20 to the vendors 16 looking to book additional meetings 19. Accordingly, as each time interval reaches the maximum number of allowed meetings 19 per interval (e.g. two), the respective time interval 18 would be removed from access by vendors 16 looking to book meetings 19 in the respective time period 12. Alternatively, in the case where the first time interval 18 has two booked meetings 19, the second time interval 18 has one booked meeting 19, and the third time interval 18 has no booked meetings 19, the first tine interval 18 would be removed from presentation (i.e. available for booking) as the maximum number of bookings per interval 18 was reached. As well, the second interval 18 could also be removed from presentation (i.e. available for booking), even though the maximum number of bookings per interval 18 was not reached, in order to encourage the last allowable booking (i.e. the maximum number of calls in the time period 12—having three time intervals 18—was specified as 4) to be positioned in the third meeting interval 18. This selective presentation of the time intervals 18 in the time period 12 would be done to promote distribution of meetings 19 in each of the available time intervals 18 (i.e. at least one meeting 19 in each but no more than two meetings 19 in any one interval 18).

In another example, in the case where there is one meeting 19 in each of the three time intervals 18, all three time intervals 18 would remain available for booking in the time period 12 for the last available meeting 19, thus promoting maximum choice selection for the vendor 16 for the last meeting 19 available in the time period 12 (i.e. max #FC was set at 4 for the time period 12). In any event, it is recognised that the flex module 106 organizes the presentation of the time intervals 18 in the schedule 20, so as to promote a distribution of meetings 19 in as many of the intervals 18 as possible.

Accordingly, the flex module 106 is configured to dynamically allocate the booked meetings in the meeting intervals 18 of the meeting period(s) 12 according to the values of BWmax and #FC discussed above, such that as the open meeting intervals 18 are booked by the vendors 16 in each of the meeting periods 12, the flex module 106 monitors the number of bookings NB in each of the meeting periods 12/intervals 18. When NB reaches the BWmax, then that meeting interval 18 may be closed to other vendors 16, who then cannot interact (i.e. view the meeting interval 18 on their user interface 202—see FIG. 3) with the closed meeting interval 18 to book their meetings 19 therein. For example, the location of the closed meeting interval 18 in the meeting schedule 20 can be presented as “busy” or “not available” to the other vendors 16 (those not having a booked meeting 19 in the fully booked meeting interval 18), as desired.

A further method implemented by the flex module 106 for distributing booked meetings in the meeting period(s) 12 can be done by calculating the maximum number (BWmax1) of meetings allowed in any meeting interval 18 as:

BWmax1=#FC/#FCW,

such that any fractional value of the BWmax1 is rounded up to the next integer value, for example. For example, if there are five potential/available meeting intervals 18 (i.e. #FCW=4) per meeting period 12 and the maximum number #FC of bookable meetings 19 defined by the customer 14 is five (i.e. #FC=5) for a selected collection of meeting intervals 18 (e.g. of a respective time period 12), then the maximum per meeting interval 18 in the schedule 20 is initially two (i.e. BWmax1=2).

In this example distribution method, the flex module 106 distributes the booked meetings 19 among the meeting intervals 18 as they are booked by the vendors 16. The flex module 106 does this by doing a recursive check each time when a particular open meeting interval 18 is booked, in order to determine when the NB in any one meeting interval 18 reaches BWmax1 and then that individual meeting interval 18 is removed from interaction with the other vendors 16 via the meeting schedule 20. Then the flex module 106 dynamically reduced the #FCW by one in the BWmax1 calculation. Also, only the remaining available meetings 19 are included in any new BWmax1 calculation for the remaining open meeting intervals 18 (i.e. available for interaction by the vendors 16), thereby also dynamically reducing the #FC used in any new BWmax1 calculation for the remaining open meeting intervals 18. This creates a new BWmax1 with the number of remaining meetings 19 (#FCrem) and the number of remaining meeting intervals 18 (#FCWrem), namely:

BWmax1=#FCrem/#FCWrem.

It is recognised that the BWmax1 calculation is repeated recursively every time one of the remaining open meeting intervals 18 has a NB reaching the new BWmax1 discussed above.

For example, in the case where there were five meeting intervals 18 and the number of meetings 19 being accepted (e.g. bookable as #FC) by the customer 14 is four (i.e. #FC=4), then no interval will accept more than one booking. If the number of meetings 19 being accepted by the customer is six (i.e. #FC=6) and the first meeting intervals 18 is filled by two separate vendors 16 who each book their respective meeting 19 within the first meeting interval 18, then that first meeting interval 18 is deemed by the flex module 106 as booked and is not viewable/presentable to subsequent vendors 16 who are looking to book their meetings 19 with the customer 14 via the customer's meeting schedule 20. Further, the remaining meeting intervals 18 will now only accept one (1) booked meeting 19 each (i.e. BWmax1 will always be equal to one). In this manner, the distribution of meetings 19 in as many of the individual meeting intervals 18 is encouraged. For example, the above-described distribution methods would discourage the filling of two of the five meeting intervals 18 completely (i.e. two each for a total of 4 booked meetings 19), leaving the other three meeting intervals 18 empty. In other words, a preferred meeting 19 distribution would be to not allow multiple meetings 19 in any one time interval 18 if the number of time intervals 18 is greater than the maximum number of allowed flex meeting 19 (i.e. #FC) for the time period 12, for example the distribution of 2-1-1-1-1 is preferred over 2-2-2-0-0 or 4-1-1-0-0 for the meetings 19 in the time intervals 18.

### Scheduler Module 108

Referring again to FIG. 2, a scheduler module 108 is used by the organizer engine 100 to interact with the vendors 16 over the network 11, in order to book in any available/open meeting period 12 and/or meeting interval 18 from a selected customer meeting schedule 20. As discussed above, the scheduler module 108 is configured to only show those meeting schedules 20 (or portions thereof—e.g. specified meeting period(s) 12 and/or meeting intervals 18) to those vendors 16 that meet the identifier check (e.g. unique and/or generic) for the respective meeting schedule 20 (or portions thereof), as specified by the respective customer 14 via the meeting parameters 21.

Further, referring again to FIG. 2, the scheduler module 108 is used by the organizer engine 100 to interact with the customers 14 over the network 11, in order to facilitate a meeting booking in any available/open meeting period 12 and/or meeting interval 18 from a selected vendor 16 meeting schedule 17. As discussed above, the scheduler module 108 can be configured to only show those meeting schedules 17 (or portions thereof—e.g. specified meeting period(s) 12 and/or meeting intervals 18) to those customers 14 that meet the identifier check (e.g. unique and/or generic) for the respective meeting schedule 17 (or portions thereof) and/or are otherwise related to the vendor 16 (e.g. on a customer list associated with the vendor 16), as specified by the respective vendor 16 via the meeting parameters 21.

### Example Operation 500 of the Organizer Engine 100

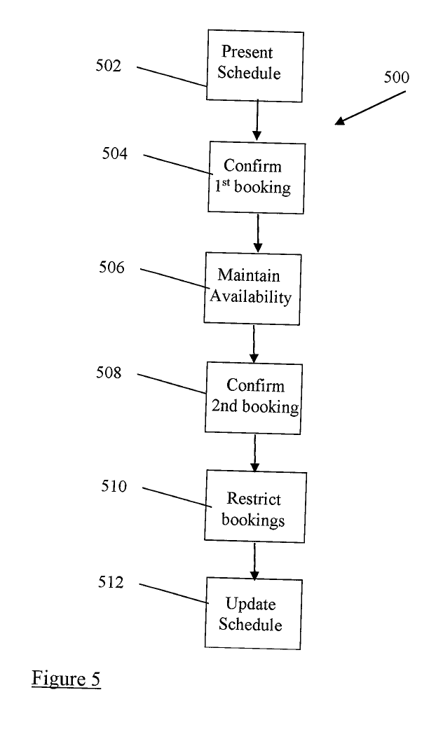

Referring to FIGS. 1 and 5, an example operation 500 of the organizer engine 100 for scheduling a meeting 19 between a schedule entity 14 and a plurality of booking entities 16 over a communications network 11 is as follows.

At step 502, the presentation module 104 presents a meeting schedule 20 of the schedule entity 14 for access by the plurality of booking entities 16, the meeting schedule 20 defining a meeting period 12 including a start time and an end time, the meeting period 12 being divided into a number of meeting intervals 18 (e.g. a first meeting interval 18 and a second meeting interval 18) such that the intervals 18 are located in the meeting period 12 between the start and end times. At step 504, the scheduler module 108 confirms booking of a first meeting 19 for a first booking entity 16 of the plurality of booking entities 16 in the first meeting interval 18. Further, the organizer engine 100 (e.g. via the flex module 106) maintains at step 506 the availability of the first meeting interval 18 to accept another meeting booking 19 by another booking entity 16 of the plurality of booking entities 16 based on a booking number threshold (e.g. #FC, #FCW, or a combination thereof, or other thresholds as desired) defining the maximum number of allowed meeting bookings for the first meeting interval 18. The schedule module 108 at step 508 confirms a second meeting 19 for a second booking entity 16 of the plurality of booking entities 16 in the same first meeting interval 18. At step 510, the flex module 106 (for example in conjunction with the presentation module 104) provides that the meeting interval(s) 18 are restricted from accepting one or more further meeting bookings 19 based on a comparison of their respective booking number threshold with a total number of booked meetings 12 in the respective meeting interval 18 and/or meeting period 12. At step 512, the flex module 106 statically or dynamically calculates the allowable number of meeting bookings 19 in any selected interval 18 based in the number threshold(s) of the interval(s) 18 and/or period(s) 12 and the presentation module 104 provides for an update of the presentation of the schedule 20 to the booking entities 16 to include any restricted interval 18 presentation based on the calculated allowable number of meeting bookings 19.

### Computing Devices 101

Referring to FIGS. 1 and 3, each of the above-described components of the system 10, e.g. the customers 14, the vendors 16, the organizer engine 100, the proxy server 99 can be implemented on one or more respective computing device(s) 101. The devices 101 in general can include a network connection interface 200, such as a network interface card or a modem, coupled via connection 218 to a device infrastructure 204. The connection interface 200 is connectable during operation of the devices 101 to the communication network 11 (e.g. an intranet and/or an extranet such as the Internet, including wireless networks), which enables the devices 101 to communicate with each other as appropriate. The network 11 can support the communication of the meeting schedule 17,20, the meeting parameters 21 and the vendor/customer selections 23 between the components of the system 10. It is recognised that the functionality of any of the components can be hosted on the user device 101 itself, hosted on a device 101 remote to the user via the network 11, or a combination thereof.

Referring again to FIG. 4, the devices 101 can also have the user interface 202, coupled to the device infrastructure 204 by connection 222, to interact with the user. The user interface 202 is used by the user of the device 101 to view and interact with the organizer engine 100. The user interface 202 can include one or more user input devices such as but not limited to a QWERTY keyboard, a keypad, a track-wheel, a stylus, a mouse, a microphone and the user output device such as an LCD screen display and/or a speaker. If the screen is touch sensitive, then the display can also be used as the user input device as controlled by the device infrastructure 204. For example, the user interface 202 for the devices 101 used by the users can be configured to interact with a web browser to formulate the configure and/or interact with the meeting schedules 17, 20 of the system 10.

Referring again to FIG. 4, operation of the devices 101 is facilitated by the device infrastructure 204. The device infrastructure 204 includes one or more computer processors 208 and can include an associated memory 210 (e.g. a random access memory). The computer processor 208 facilitates performance of the device 101 configured for the intended task through operation of the network interface 200, the user interface 202 and other application programs/hardware 207 of the device 101 by executing task related instructions. These task related instructions can be provided by an operating system, and/or software applications 207 located in the memory 210, and/or by operability that is configured into the electronic/digital circuitry of the processor(s) 208 designed to perform the specific task(s).

Further, it is recognized that the device infrastructure 204 can include a computer readable storage medium 212 coupled to the processor 208 for providing instructions to the processor 208 and/or to load/update client applications 207 and the organizer engine 100 if locally accessed by the user. The computer readable medium 212 can include hardware and/or software such as, by way of example only, magnetic disks, magnetic tape, optically readable medium such as CD/DVD ROMS, and memory cards. In each case, the computer readable medium 212 may take the form of a small disk, floppy diskette, cassette, hard disk drive, solid-state memory card, or RAM provided in the memory module 210. It should be noted that the above listed example computer readable mediums 212 can be used either alone or in combination. The device memory 210 and/or computer readable medium 212 can be used to store the meeting schedule 20 information.

Further, it is recognized that the computing devices 101 can include the executable applications 100, 207 comprising code or machine readable instructions for implementing predetermined functions/operations including those of an operating system, a web browser, the organizer engine 100 for example. The processor 208 as used herein is a configured device and/or set of machine-readable instructions for performing operations as described by example above. As used herein, the processor 208 may comprise any one or combination of, hardware, firmware, and/or software. The processor 208 acts upon information by manipulating, analyzing, modifying, converting or transmitting information for use by an executable procedure or an information device, and/or by routing the information with respect to an output device. The processor 208 may use or comprise the capabilities of a controller or microprocessor, for example. Accordingly, any of the functionality of any of the modules (and subsets thereof) of the organizer engine 100 may be implemented in hardware, software or a combination of both. Accordingly, the use of a processor 208 as a device and/or as a set of machine-readable instructions is hereafter referred to generically as a processor/module for sake of simplicity.

It will be understood that the computing devices 101 of the users may be, for example, personal computers, personal digital assistants, and mobile phones. Server computing devices 101 can be configured for the proxy server 99, as desired. Further, it is recognised that each computing device 101, although depicted as a single computer system, may be implemented as a network of computer processors, as desired.

1. A method for scheduling a meeting between a schedule entity and a plurality of booking entities over a communications network, the method comprising the steps of:
presenting a meeting schedule of the schedule entity for access by the plurality of booking entities, the meeting schedule defining a meeting period including a start time and an end time, the meeting period being divided into a first meeting interval and a second meeting interval such that the intervals are located in the meeting period between the start and end times;
confirming booking of a first meeting for a first booking entity of the plurality of booking entities in the first meeting interval;
maintaining the availability of the first meeting interval to accept another meeting booking by another booking entity of the plurality of booking entities based on a booking number threshold defining the maximum number of allowed meeting bookings for the first meeting interval; and
confirming a second meeting for a second booking entity of the plurality of booking entities in the same first meeting interval;
wherein the meeting intervals are restricted from accepting one or more further meeting bookings based on a comparison of their respective booking number threshold with a total number of booked meetings in the respective meeting interval.

2. The method of claim 1, wherein the booking number threshold of the first meeting interval is a first booking number threshold, the second meeting interval has a second booking number threshold, and the meeting period has a period booking number threshold defining the maximum number of allowed meeting bookings for the meeting period.

3. The method of claim 2, wherein the period booking number threshold is a combination of the first and second booking number thresholds.

4. The method of claim 2 further comprising the step of restricting booking access to the first meeting interval by others of the plurality of booking entities in order to provide for selection of the second meeting interval for a third meeting booking.

5. The method of claim 4, wherein the access to the first meeting interval is restricted by removing the first meeting interval from the presentation of the meeting schedule.

6. The method of claim 4, wherein the access to the first meeting interval is restricted before the number of confirmed meeting bookings for the first meeting interval reaches the first booking number threshold.

7. The method of claim 4 further comprising the step of comparing the total number of confirmed meeting bookings for the first and second meeting intervals to the period booking number threshold in deciding whether to restrict access to the first meeting interval, in order to promote selection of the second meeting interval by another of the plurality of booking entities.

8. The method of claim 7, wherein the schedule entity is in a customer-vendor relationship with one or more of the plurality of booking entities.

9. The method of claim 8, wherein the schedule entity is defined as a customer role of the customer-vendor relationship and the one or more of the plurality of booking entities are defined as a vendor role of the customer-vendor relationship.

10. The method of claim 1 further comprising the step of distributing the first meeting interval and the second meeting interval as overlapping intervals in the meeting period, such that an interval end time of the first meeting interval is defined after an interval start time of the second meeting interval where the first meeting interval is positioned before the second meeting interval in the meeting period.

11. A system for scheduling a meeting between a schedule entity and a plurality of booking entities over a communications network, the method comprising the steps of:
a presentation module for presenting a meeting schedule of the schedule entity for access by the plurality of booking entities, the meeting schedule defining a meeting period including a start time and an end time, the meeting period being divided into a first meeting interval and a second meeting interval such that the intervals are located in the meeting period between the start and end times; and
an scheduler module for confirming booking of a first meeting for a first booking entity of the plurality of booking entities in the first meeting interval, and further configured for maintaining the availability of the first meeting interval to accept another meeting booking by another booking entity of the plurality of booking entities based on a booking number threshold defining the maximum number of allowed meeting bookings for the first meeting interval, and further configured for confirming a second meeting for a second booking entity of the plurality of booking entities in the same first meeting interval;
wherein the meeting intervals are restricted from accepting one or more further meeting bookings based on a comparison of their respective booking number threshold with a total number of booked meetings in the respective meeting interval.

12. The system of claim 11, wherein the booking number threshold of the first meeting interval is a first booking number threshold, the second meeting interval has a second booking number threshold, and the meeting period has a period booking number threshold defining the maximum number of allowed meeting bookings for the meeting period.

13. The system of claim 12, wherein the period booking number threshold is a combination of the first and second booking number thresholds.

14. The system of claim 12 further comprising a flex module configured for restricting booking access to the first meeting interval by others of the plurality of booking entities in order to provide for selection of the second meeting interval for a third meeting booking.

15. The system of claim 14, wherein the access to the first meeting interval is restricted by removing the first meeting interval from the presentation of the meeting schedule.

16. The system of claim 14, wherein the access to the first meeting interval is restricted before the number of confirmed meeting bookings for the first meeting interval reaches the first booking number threshold.

17. The system of claim 14 further comprising the flex module configured for comparing the total number of confirmed meeting bookings for the first and second meeting intervals to the period booking number threshold in deciding whether to restrict access to the first meeting interval, in order to promote selection of the second meeting interval by another of the plurality of booking entities.

18. The system of claim 17, wherein the schedule entity is in a customer-vendor relationship with one or more of the plurality of booking entities.

19. The system of claim 18, wherein the schedule entity is defined as a customer role of the customer-vendor relationship and the one or more of the plurality of booking entities are defined as a vendor role of the customer-vendor relationship.

20. The system of claim 11 further comprising the presentation module configured for distributing the first meeting interval and the second meeting interval as overlapping intervals in the meeting period, such that an interval end time of the first meeting interval is defined after an interval start time of the second meeting interval where the first meeting interval is positioned before the second meeting interval in the meeting period.

21. The system of claim 20, wherein the meeting schedule contains a plurality of the meeting periods, such that at least some of the plurality of the meeting periods contains a plurality of meeting intervals distributed over a duration of their respective meeting period.
